(19) United States
(12) Patent Application Publication
(10) Pub. No.: US 2019/0191004 A1
(43) Pub. Date: Jun. 20, 2019

(54) SYSTEM AND METHOD TO REDUCE NETWORK TRAFFIC AND LOAD OF HOST SERVERS

(71) Applicant: Hitachi, Ltd., Chiyoda-ku, Tokyo (JP)

(72) Inventor: Hiroshi NAKAGOE, Los Gatos, CA (US)

(73) Assignee: Hitachi ,Ltd., Chiyoda-ku ,Tokyo (JP)

(21) Appl. No.: 16/327,257

(22) PCT Filed: May 23, 2017
(86) PCT No.: PCT/US2017/034080

§ 371 Date: Feb. 21, 2019

(51) Int. Cl. H04L 29/08; H04L 29/12

(52) U.S. Cl. CPC H04L 67/2857; H04L 61/1511; H04L 67/12

(57) ABSTRACT

Example implementations described herein involve a system, which can involve a first apparatus having a memory, configured to manage a plurality of rules and a plurality of sub-rules for merging requests; and a processor, configured to receive a plurality of requests, each of the plurality of requests comprising header information and body information; select a rule from the plurality of rules in the memory for the plurality of requests, based on the header information of the plurality of requests; select a sub-rule from ones of the plurality of sub-rules corresponding to the selected rule in the memory for the plurality of requests, based on the body information of the plurality of requests; generate a merged request from an execution of a merger operation on the plurality of requests based on the selected rule and the selected sub-rule; and transmit the merged request to a second apparatus.

### BACKGROUND

### Field

The present disclosure relates generally to communication systems, and more specifically, to network management for systems involving Internet of Things (IoT) devices.

### Related Art

In related art systems, devices such as sensors, controllers of manufactured products, phones and tablets, are connected to a network, and their data is gathered into core services, such as analytics services, on cloud. Such systems are known as IoT or “Internet of Things”. In an IoT system, many devices send requests to push their sensed data and pull commands or search results from core services. Each of the requests is typically small, but each of the devices sends many requests. As such requests involve core servers that provide core services, the resultant network traffic may exceed the capacity of the core servers and associated networks.

In an example related art implementation, U.S. Pat. No. 6,108,703, a “Global hosting system” involves a framework to distribute network traffic load of host servers by steering client requests to cache servers that are nearby clients.

However, related art implementations only involve obtaining static content from nearby cache servers. Specifically, related art implementations are directed to detecting which cache servers are near clients, and transmitting content corresponding to client request from cache servers if the cache servers have the corresponding contents. Related art implementations do not address the network traffic load of host servers which have dynamic web sites.

In another related art implementation, there is the provision for accelerating user access to dynamic web sites. Such related art implementations are directed to creating secure connections between cache servers and host servers directly, which is the shortest path between them. Such related art implementations are not directed to reducing network traffic loads of host servers.

In related art IoT systems, core services are similar to dynamic websites and devices do not send their requests with a static location. For instance, in related art IoT systems, a device sends its sensed data to core servers wherein the data is analyzed. The device sends a Hyper Text Transfer Protocol (HTTP) GET request to the Universal Resource Locator (URL), which can be in the form such as “http://www.aaa.bbb/api?sensor1=100&sensor2=1”. The URL indicates that the device sends “100” and “1” as value of sensor 1 and sensor 2 respectively. In such an example case, the device will send data to the different URL corresponding to sensed values.

### SUMMARY

Example implementations of the present disclosure are directed to transmitting client requests to cache servers without modifying the client configuration through the use of Domain Name Service (DNS). Thus, the client is able to acquire contents faster, and host servers can reduce their network traffic load.

In IoT systems, most devices tend to send their requests within a similar format because of two reasons. First is that a company utilizes many of devices, of which some of them are the same type of devices, and all their devices may be based on the same framework. Thus, such devices tend to send similar messages. Second is that a lot of the framework utilize standards such as Representational State Transfer (REST), and format data with JavaScript Object Notation (JSON) and Yet Another Markup Language (YAML) respectively. Such implementations allow for easier facilitation for analyzing data.

Example implementations can involve a gateway on the edge-side or the center side to gather client sensor data from a lot of devices, find requests which can be merged to one request and send merged requests to host servers. Example implementations can further include a gateway on the edge-side or center side to receive responses from core services, which responses are merged and implicitly contained results for a lot of devices. This gateway unmerges the merged response, transmitting them to each of devices.

Aspects of the present disclosure include a system, which can involve a first apparatus including a memory, configured to manage a plurality of rules and a plurality of sub-rules for merging requests; and a processor, configured to receive a plurality of requests, each of the plurality of requests including header information and body information; select a rule from the plurality of rules in the memory for the plurality of requests, based on the header information; select a sub-rule from ones of the plurality of sub-rules corresponding to the selected rule in the memory for the plurality of requests, based on the body information; generate a merged request from an execution of a merger operation on the plurality of requests based on the selected rule and the selected sub-rule; and transmit the merged request to a second apparatus.

Aspects of the present disclosure further include a method, which can involve managing a plurality of rules and a plurality of sub-rules for merging requests; receiving a plurality of requests, each of the plurality of requests including header information and body information; selecting a rule from the plurality of rules for the plurality of requests, based on the header information of the plurality of requests; selecting a sub-rule from ones of the plurality of sub-rules corresponding to the selected rule for the plurality of requests, based on the body information of the plurality of requests; generating a merged request from an execution of a merger operation on the plurality of requests based on the selected rule and the selected sub-rule; and transmitting the merged request to an apparatus.

Aspects of the present disclosure further include a computer program containing instructions for executing a process, the instructions including managing a plurality of rules and a plurality of sub-rules for merging requests; receiving a plurality of requests, each of the plurality of requests including header information and body information; selecting a rule from the plurality of rules for the plurality of requests, based on the header information of the plurality of requests; selecting a sub-rule from ones of the plurality of sub-rules corresponding to the selected rule for the plurality of requests, based on the body information of the plurality of requests; generating a merged request from an execution of a merger operation on the plurality of requests based on the selected rule and the selected sub-rule; and transmitting the merged request to an apparatus. The computer program can be stored on a non-transitory computer readable medium and the instructions can be executed by one or more processors.

Aspects of the present disclosure further include a system, which can involve means for managing a plurality of rules and a plurality of sub-rules for merging requests; means for receiving a plurality of requests, each of the plurality of requests comprising header information and body information; means for selecting a rule from the plurality of rules for the plurality of requests, based on the header information of the plurality of requests; means for selecting a sub-rule from ones of the plurality of sub-rules corresponding to the selected rule for the plurality of requests, based on the body information of the plurality of requests; means for generating a merged request from an execution of a merger operation on the plurality of requests based on the selected rule and the selected sub-rule; and means for transmitting the merged request to an apparatus.

### BRIEF DESCRIPTION OF DRAWINGS

FIG. 1 illustrates an example system upon which the first example implementation may be implemented.

FIG. 2 illustrates an example flow chart for merging device requests and sending the merged requests for the gateway, in accordance with a first example implementation.

FIG. 3 illustrates an example flow chart for unmerging response from core servers, in accordance with a first example implementation.

FIGS. 4 to 6 illustrate example tables that can be stored in the rule database (DB), in accordance with a first example implementation.

FIGS. 7 through 10 illustrate examples of the filter rule, in accordance with an example implementation.

FIG. 11 illustrates an example table stored in the merged request DB, in accordance with a first example implementation.

FIG. 12 illustrates an example for unmerging the response related with the merged request from FIG. 7 and FIG. 8, in accordance with an example implementation.

FIG. 13 shows an example of how to unmerge a response related with the merged request by FIG. 9 and FIG. 10, in accordance with a first example implementation.

FIG. 14 illustrates an example regarding selection of device requests, in accordance with a first example implementation.

FIG. 15 illustrates an example system upon which the second example implementation may be applied.

FIG. 16 illustrates an example flow chart of the core gateway for unmerging requests and sending the unmerged requests to core servers, in accordance with a second example implementation.

FIG. 17 illustrates a flow chart of the core gateway for merging responses from core servers, in accordance with a second example implementation.

FIGS. 18 through 20 illustrate examples of applications of filter rules, in accordance with a second example implementation.

FIG. 21 illustrates examples of unmerged requests, in accordance with an example implementation.

FIG. 22 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In a first example implementation described herein, there is a core use case for merging and unmerging device requests.

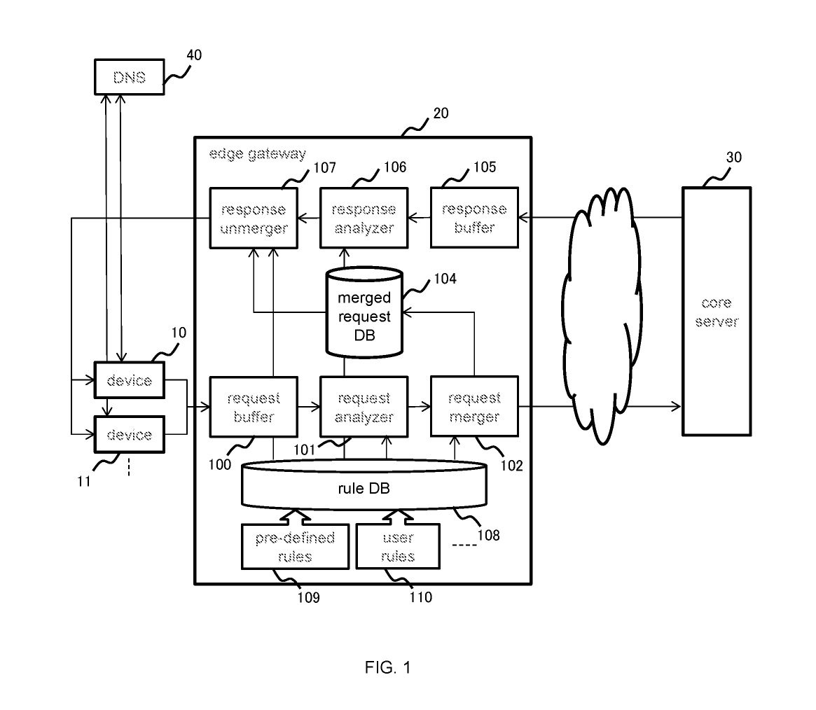

FIG. 1 illustrates an example system upon which the first example implementation may be implemented. Edge gateway 20 can include request buffer 100 configured to buffer requests from devices 10, 11 within a specific time window. Request analyzer 101 is configured to analyze requests to be merged or not by using rule database (DB) 108. Request merger 102 is configured to merge request. Merged request DB 104 is configured to store information about merged requests. Response buffer 105 is configured to buffer response from core servers 30, response analyzer 106 configured to analyze responses and detect responses related to merged requests by using merged request DB 104 and rule DB 108. Response unmerger 107 is configured to unmerge responses related with merged requests by using merged request DB 104 and rule DB 108. Rule DB 108 is configured to store rules for merging and unmerging and being pluggable with pre-defined 109 and user defined rules 110. DNS 40 is a DNS server configured to resolve the domain name and steer device requests to reach edge gateway 20 even when the destination of device request is to the core servers 30. The edge gateway 20 can also be located on the core side, depending on the desired implementation. When the gateway is placed on the edge side, example implementations can facilitate the reduction of network traffic and host server load. If the gateway is disposed on the core side, example implementations can facilitate load reduction on the host server through the same configuration as illustrated in FIG. 1.

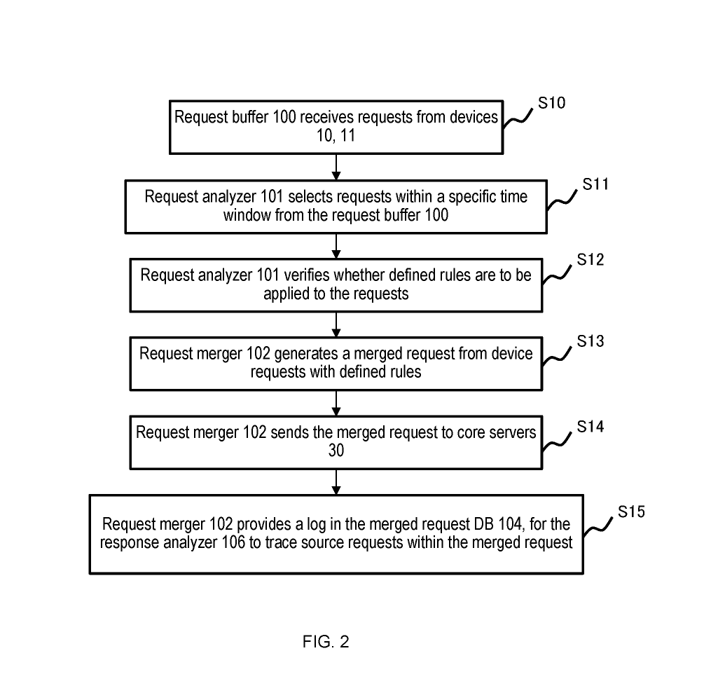

FIG. 2 illustrates an example flow chart for merging device requests and sending the merged requests for the gateway 20, in accordance with a first example implementation. The request buffer 100 receives requests from devices 10, 11 (S10). The request analyzer 101 selects some requests within a specific time window from the request buffer 100 (S11). The request analyzer 101 filters the requests and verifies whether the defined rules, stored in rule DB 108, are to be applied to the requests (S12). The request merger 102 merges the requests by using the defined rules, stored in rule DB 108 (S13). The request merger 102 sends the merged request to core servers 30 (S14). Finally, the request merger 102 provides a log to the merged request DB 104, which can be used by the response analyzer 106 to trace source requests within the merged request (S15).

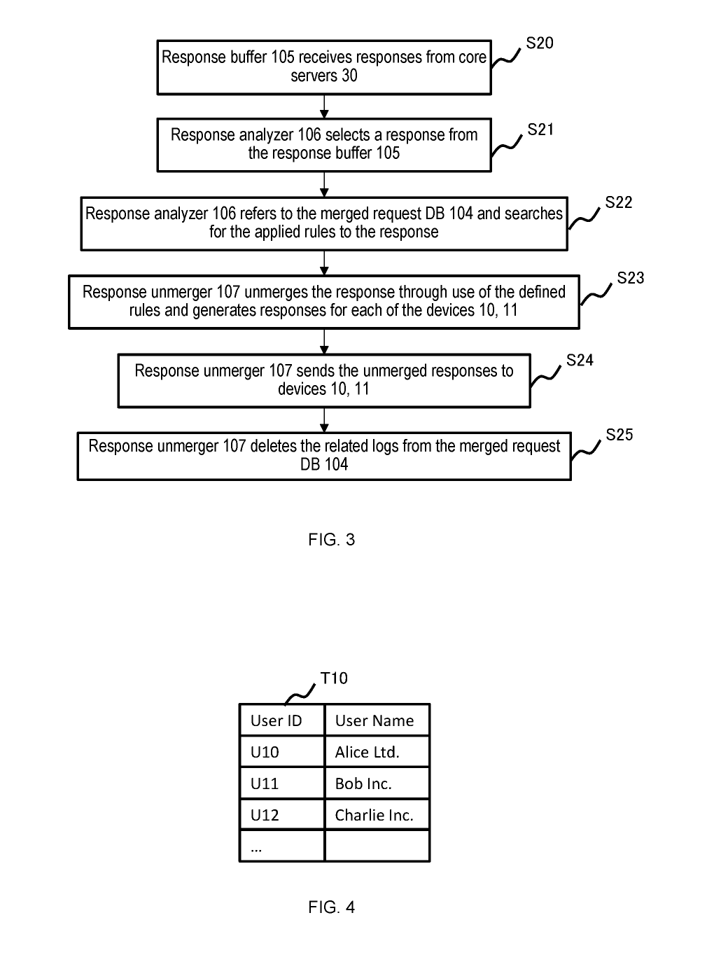

FIG. 3 illustrates an example flow chart for unmerging response from core servers, in accordance with a first example implementation. Specifically, FIG. 3 illustrates how the gateway 20 unmerges responses from core servers 30, which is just responses to the merged requests, and send the unmerged responses to each of devices 10, 11. The response buffer 105 receives responses from core servers 30 (S20). The response analyzer 106 selects a response from the response buffer 105 (S21). On unmerging, the response analyzer 106 does not need to apply the specific time window used in the merge, as the responses are generated in batch. The response analyzer 106 refers to the merged request DB 104 to find the rules applied to merging the response (S22). The response unmerger 107 unmerges the response through use of the rules and generates responses for each of the devices 10, 11 (S23). The response unmerger 107 sends the unmerged responses to each of the devices 10, 11 (S24). Finally, the response unmerger 107 deletes the related log from the merged request DB (S25).

FIG. 4 illustrates an example table T10 as stored in rule DB 108, in accordance with a first example implementation. Specifically, table T10 stores the relationship between user identifiers (IDs) and user names. In example implementations described herein, the User ID is referred in other DBs.

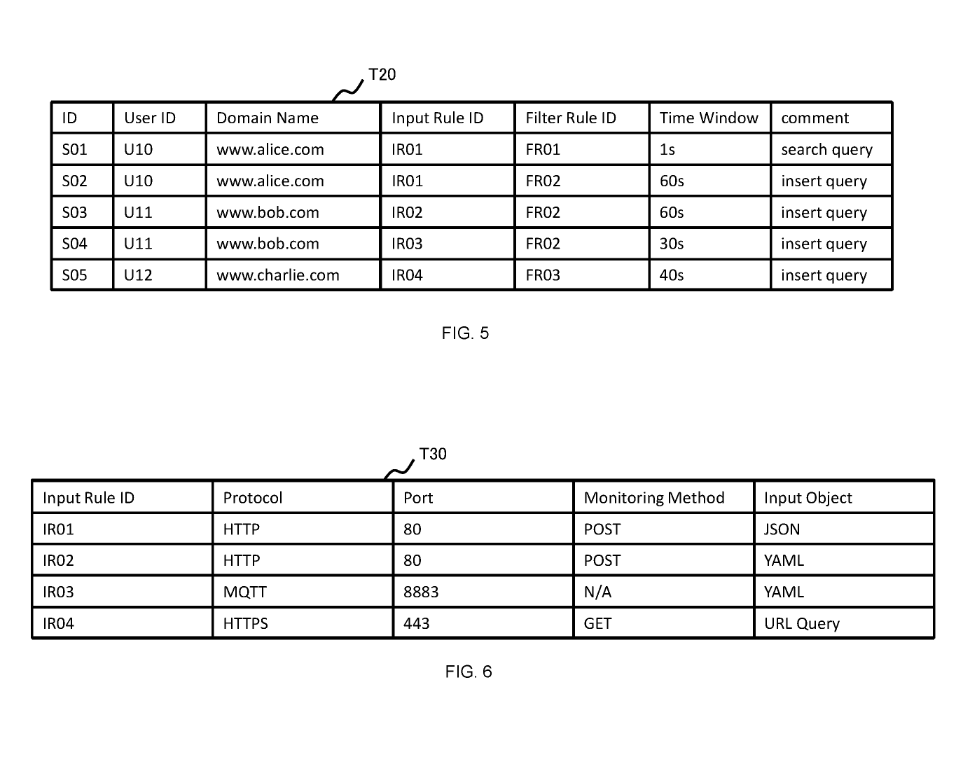

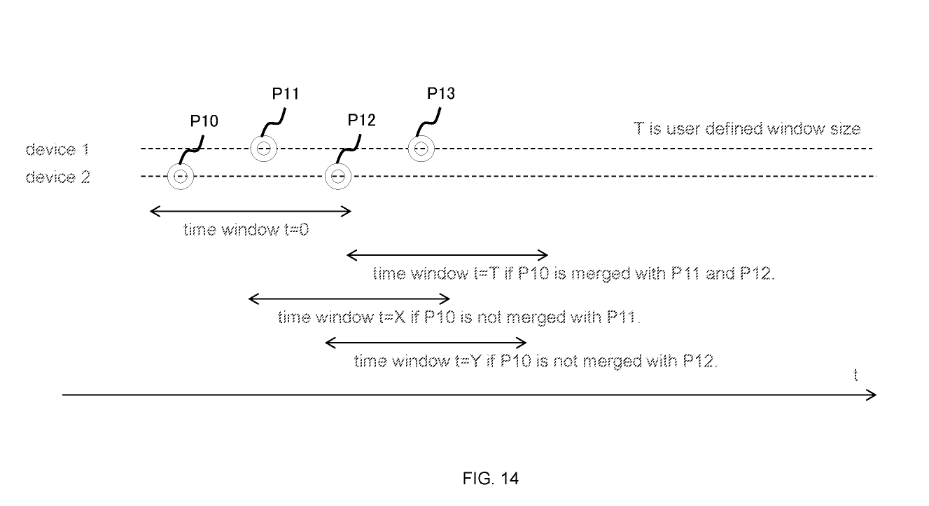

FIG. 5 illustrates an example table T20 as stored in rule DB 108, in accordance with a first example implementation. Specifically, table T20 stores site information regarding the connections of each device managed by the systems. T20 includes columns for site ID, user ID, domain name, input rule ID, filter rule ID and time window. Site ID is used to identify the target site. User ID is used to identify the user as indicated in table T10. Domain name is shown as the name of the target site. Input rules ID is used to identify the rules used to detect contents to be merged. Filter rule ID is used to identify the rules used to filter and merge contents. Time window indicates how much time each request can be delayed after it arrives in the request buffer 100. More details regarding the time window are described with respect to FIG. 14.

In example implementations described herein, filter rule ID indicates the rules used to filter and merge contents as applied to the header information of the requests (e.g., Transmission Control Protocol (TCP) headers or HTTP headers). Such filter rules may be associated with sub-rules applied to the filtering or merging of body information or content information of the requests (e.g. HTTP body content, JSON body content, etc.). Examples of header information and body information are shown at FIG. 21.

FIG. 6 illustrates an example table T30 stored in rule DB 108, in accordance with a first example implementation. Specifically, table T30 stores the details of input rule. Table T30 includes columns for the input rule ID, protocol, port, target method and target object format. Input rule ID is the same as input rule ID in table T20. Others columns, such as protocol, port, target method and target object format, are used to identify what interface the request analyzer 101 should monitor. For instance, in an example for the first row, input rule ID IR01 is used for the site of S01 and S02 indicated in table T20. IR01 is a rule that indicates that the request analyzer 101 should monitor HTTP protocol and 80 port and detect HTTP GET method. Finally, in IR01, JSON data is extracted and merged by the request merger 102.

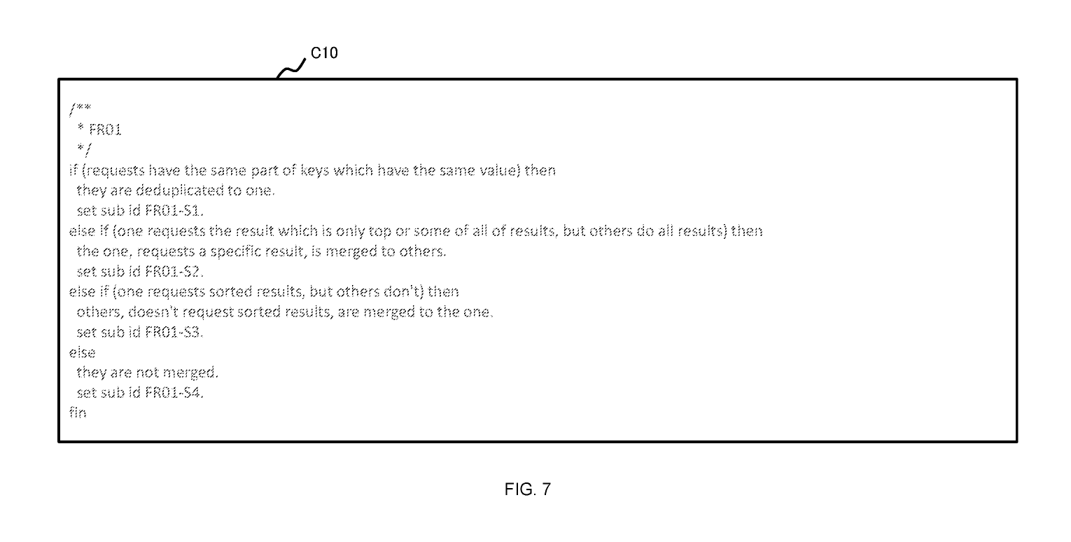

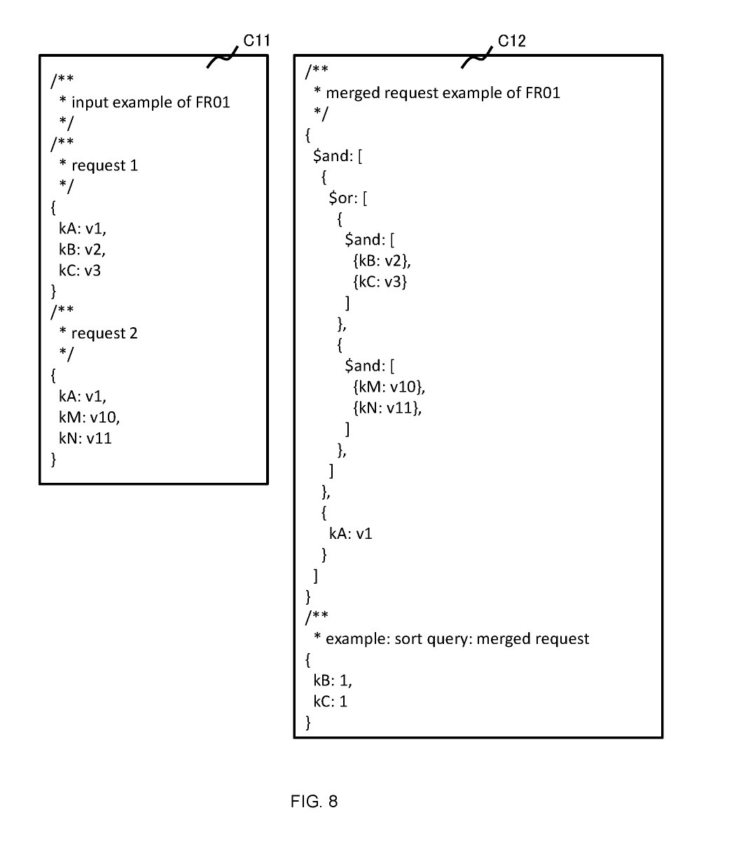

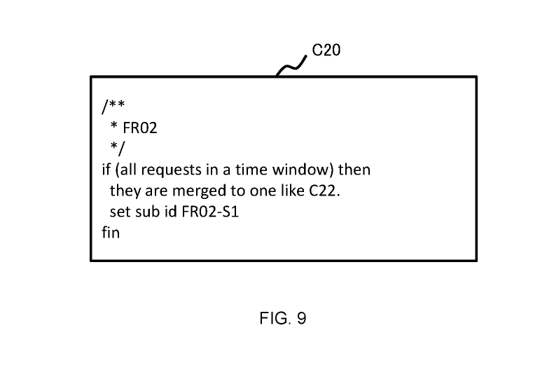

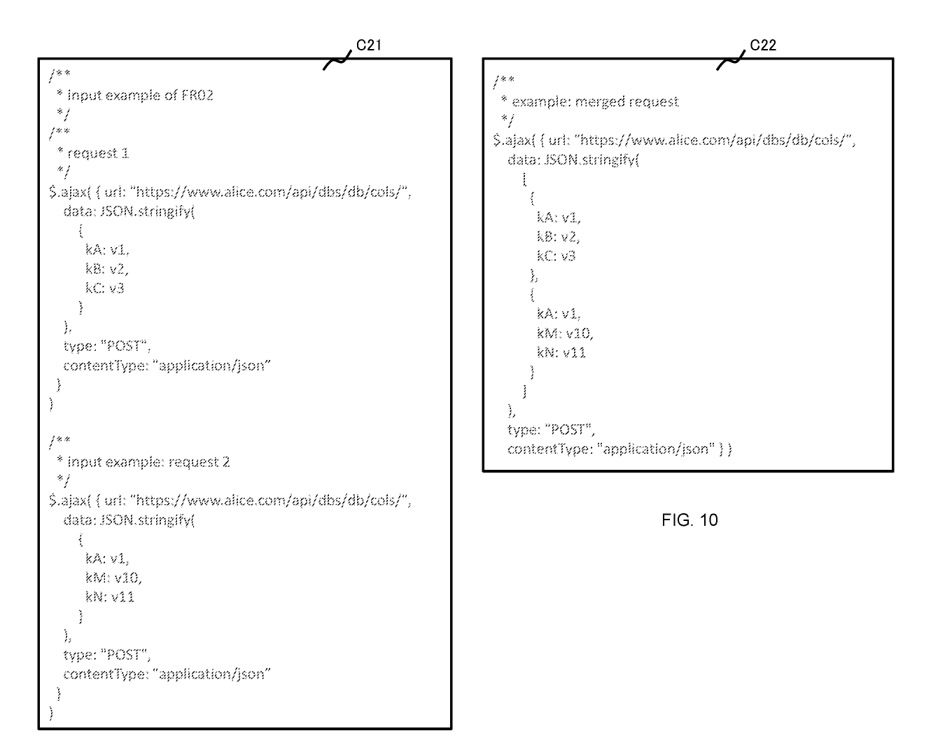

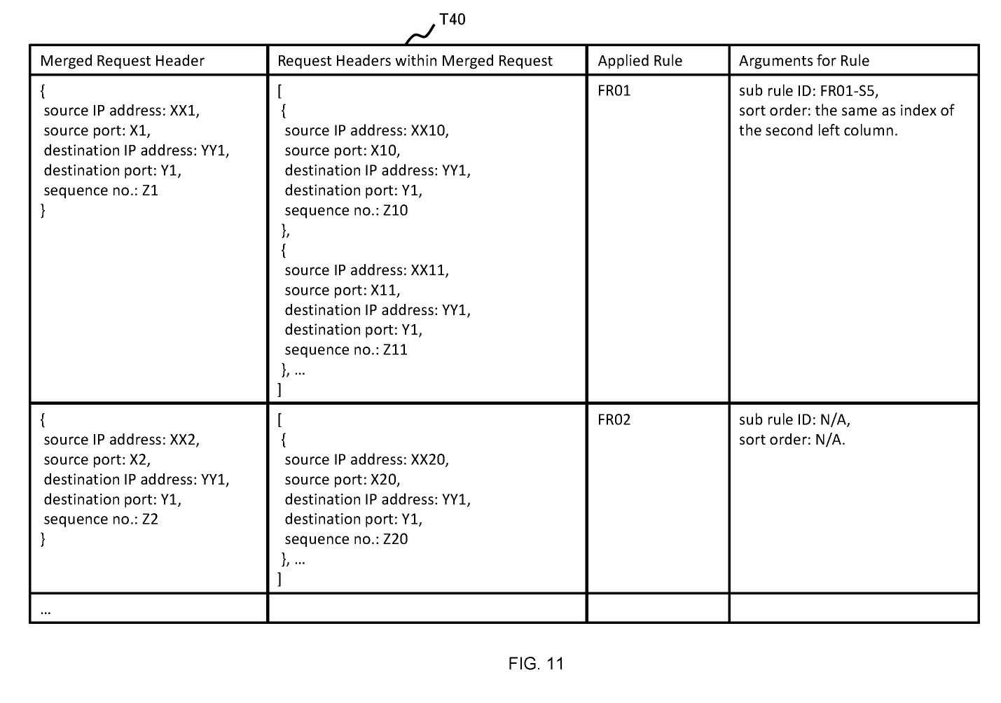

FIGS. 7 through 10 illustrate examples of filter rules, in accordance with an example implementation. Specifically, FIG. 7 and FIG. 8 illustrate an example of filter rules FR01. In this example, filter rules FR01 is adopted to merge requests, including search conditions, sent to “www.alice.com” as indicated by site ID S01 in table T20. FIG. 9 and FIG. 10 illustrate an example of filter rules FR02. In this example, filter rules FR02 is adopted to merge requests, including an insert command and its data into “www.alice.com”, as indicated by site ID S02 in table T20. These filters are assumed to be created by users. However, other implementations for automatic generation are also possible depending on the desired implementation. The merger service provider also provides the rules for public Web application programming interfaces (APIs). Thus, the format of the merged request is acceptable to core servers.

FIG. 7 illustrates an example of filter rule FR01, which is identified as C10, in accordance with a first example implementation. Based on the flow diagram of FIG. 2, the request analyzer 101 monitors the requests on the request buffer 100 and obtains target JSON objects from the requests by using rule IR01 in accordance with S11. Then the request analyzer 101 analyzes those objects by using filter rules FR01 in accordance with S12. For instance, suppose the request analyzer 101 decides to de-duplicate all requests to one when all requests have the same key and values, which is shown as sub-rule FR01-S1. In the different case, all requests are merged like C12 shown in FIG. 8 when all requests have some different keys or values, which are a few less than N, wherein N is a user defined constant, which is shown as sub-rule FR01-S4. In any case, the request analyzer 101 can set sub ID to identify which sub rule is applied, upon which a merged request can be generated in accordance with S13.

FIG. 8 illustrates an example of merging some requests, in accordance with a first example implementation. Specifically, FIG. 8 illustrates an example execution for the flow at S13 of FIG. 2 based on the filter rule illustrated in FIG. 7. The merging of requests is illustrated in the form of example pseudo code C11 and C12 for ease of understanding. C11 has two JSON data, each of which is sent from different devices or from the same devices at the different time. In this case, two JSON data have some different keys and values, each key indicated as “kB”, “kC”, “kM” and “kN”, and the corresponding values include “v2”, “v3”, “v10” and “v11” respectively. C12 makes a merged request to be able to search with the conditions of ‘request 1’ or ‘request 2’. C12 also facilitates the search option to sort a search result. This helps the response unmerger 107 to detect what rule and sub rule are applied and to unmerge the merged request. If a sort condition is not specified, then items may be mixed in search result randomly which would require the response unmerger 107 to re-search for the corresponding items.

FIG. 9 illustrates an example of filter rule FR02, which is identified as C20, in accordance with a first example implementation. In this example, FR02 has only one sub rule, which means that all requests are merged as shown at C22 by the request merger 102. The request merger 102 also sets sub ID FR02-S1 to identify what rule is adopted.

FIG. 10 shows an example of merging requests, in accordance with a first example implementation. Specifically, FIG. 10 illustrates an example execution for the flow at S13 of FIG. 2 based on the filter rule as illustrated in FIG. 9. In this example, FIG. 10 illustrates pseudo code examples C21 and C22 for ease of understanding. C21 has two requests, each of which is sent from different devices or from the same devices at the different time. In this example, two JSON data, to be sent independently, have the different keys and values, the keys indicated as “kB”, “kC”, “kM” and “kN”, and the values indicated as “v2”, “v3”, “v10” and “v11” respectively. C22 makes a merged request to insert two objects in one request simultaneously.

FIG. 11 illustrates an example table T40 stored in the merged request DB 104, in accordance with a first example implementation. Table T40 temporarily stores information about the merged requests. Table T40 is utilized for the response unmerger 107 to identify a related request with response. Table T40 includes the header of the merged request, headers of the device requests within merged requests, the rule ID applied to the merged request and associated arguments given to the response unmerger 107. The header of the merged request is used for the response analyzer 106 to relate the response with the corresponding merged request. Generally, the source internet protocol (IP) address, source port, destination IP address, destination port and sequence number are used for the header of the merged request, however, other implementations can also be conducted in accordance with the desired implementation. In this example, destination IP address YY1 and its port Y1 is associated with“www.alice.com”. The headers for the device requests within the merged requests are used by the response unmerger 107 to detect what device requests are included in the merged request. Rule ID is applied to the merged request and some arguments are used for the response unmerger 107 to determine how to unmerge the response.

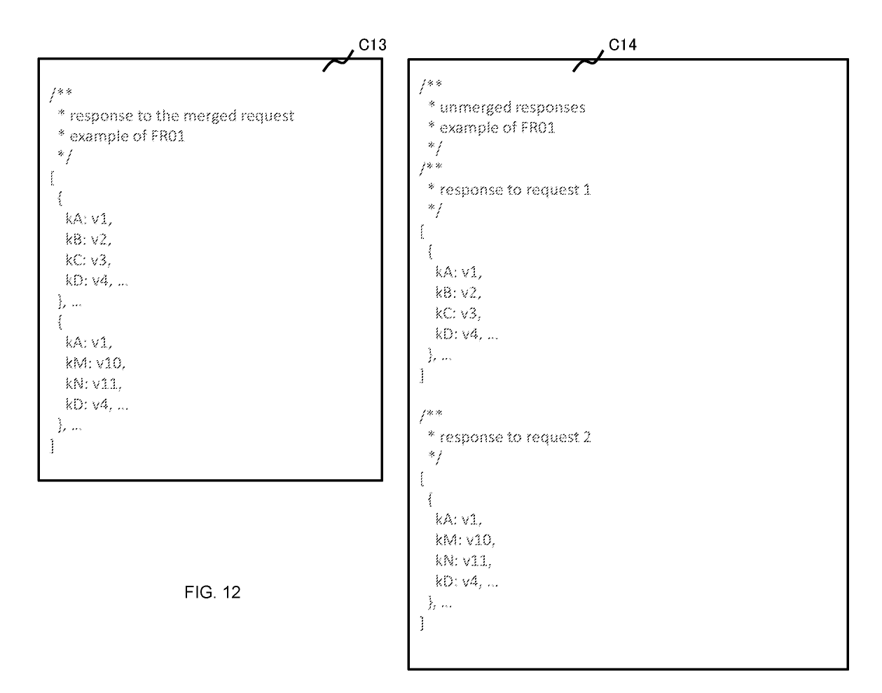

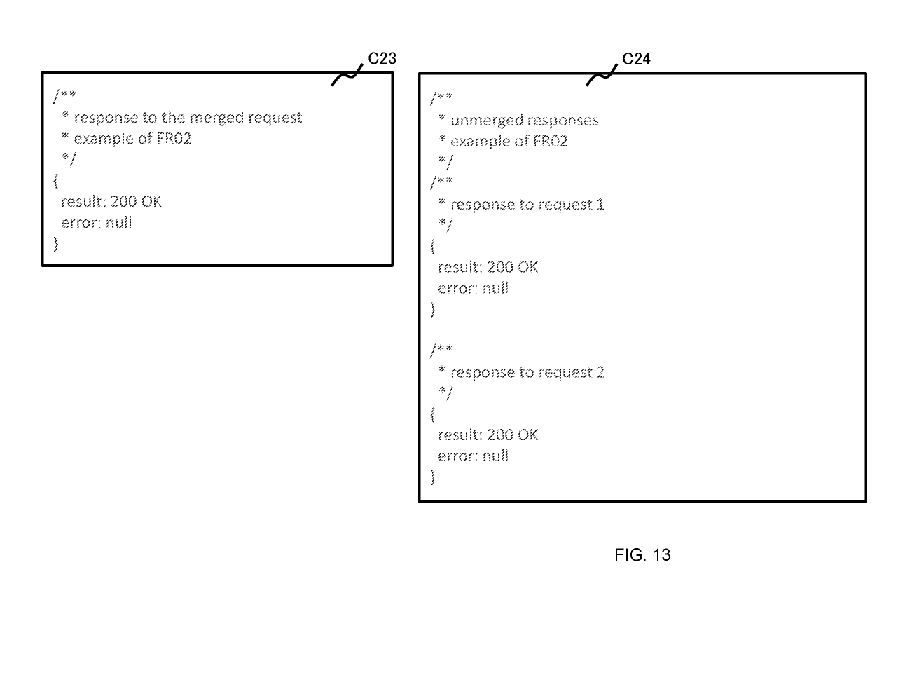

FIG. 12 illustrates an example for unmerging the response related with the merged request from FIG. 7 and FIG. 8, in accordance with an example implementation. Specifically, FIG. 12 illustrates an example of the execution of S23 of FIG. 3 in view of a received response to merged requests as illustrated in FIG. 8 from execution of filter rules as illustrated in FIG. 7. FIG. 12 illustrates two pseudo code examples C13 and C14 for ease of understanding. C13 illustrates a response including search results. The response analyzer 106 detects that the content of C13 is a response related with the merged request of FIG. 8 by using the log provided to the merged request DB 104, in accordance with the flow at S22 of FIG. 3. The response unmerger 107 unmerges the response content and splits the two contents as shown at C14, through doing a reverse execution of the filter rule provided in FIG. 7, in accordance with the flow of S23 of FIG. 3. In this example, the response unmerger 107 determines how to split the response content by using column “rule ID applied to the merged request” and “some arguments” in the merged request DB 104. In detail, C13 is sorted as the same sequence as the device requests in column “headers of device's request within merged requests” in the merged request DB 104, which allows the system to determine which portion of the response corresponds to which device.

FIG. 13 shows an example of how to unmerge a response related with the merged request by FIG. 9 and FIG. 10, in accordance with a first example implementation. Specifically, FIG. 13 illustrates an example of the execution of S23 of FIG. 3 in view of a received response to merged requests as illustrated in FIG. 9 and FIG. 10. FIG. 13 illustrates two pseudo code examples C23 and C24 for ease of understanding. In this example, the response unmerger 107 unmerges the response C23 through the reverse application of filter rule FR02 as illustrated in FIG. 9. As noted in the merged request DB log, two requests correspond to the device as would be provided to the merged request DB 104 and as illustrated in FIG. 10. In this case, the response unmerger 107 performs the inverse of the filter rule FR02 (i.e., duplicating the response to reverse the merging of the request), whereupon response unmerger S107 sends the unmerged response C24 to each of the related devices based on the identification of such devices from merged request DB 104, and as executed in S24 of FIG. 3.

FIG. 14 illustrates an example regarding selection of device requests, in accordance with a first example implementation. The example of FIG. 14 involves two devices, device 1 and 2, send requests, P10 through P13, to a site. In this case, the first example implementation counts time from when each of the requests arrives. For instance, the request analyzer 101 waits for time window T from when P10 has arrived. T in this case is the user defined time window size. The request analyzer 101 can obtain P10 through P12 during the time window T and analyze whether to merge the obtained requests. If P11 and P12 are merged with P10, the request analyzer 101 starts the next time window from when P12 has arrived. If P11 is merged but P12 is not, the request analyzer 101 starts the next time window from when P12 has arrived. If P12 is merged but P11 is not, the request analyzer 101 starts the next time window from when P11 is arrived.

In a second example implementation, there is an extended use case that can also incorporate some or all of the aspects of the first example implementation, depending on the desired implementation. The second example implementation involves gateways on both the edge and the core side. The core side gateway is configured to unmerge the merged requests made by the edge side gateway. Such an example implementation is directed to the reduction of network traffic, however, core servers may not have an interface to accept the merged request. In the second example implementation, overlapping aspects of the first example implementation are indicated from repeated reference numerals.

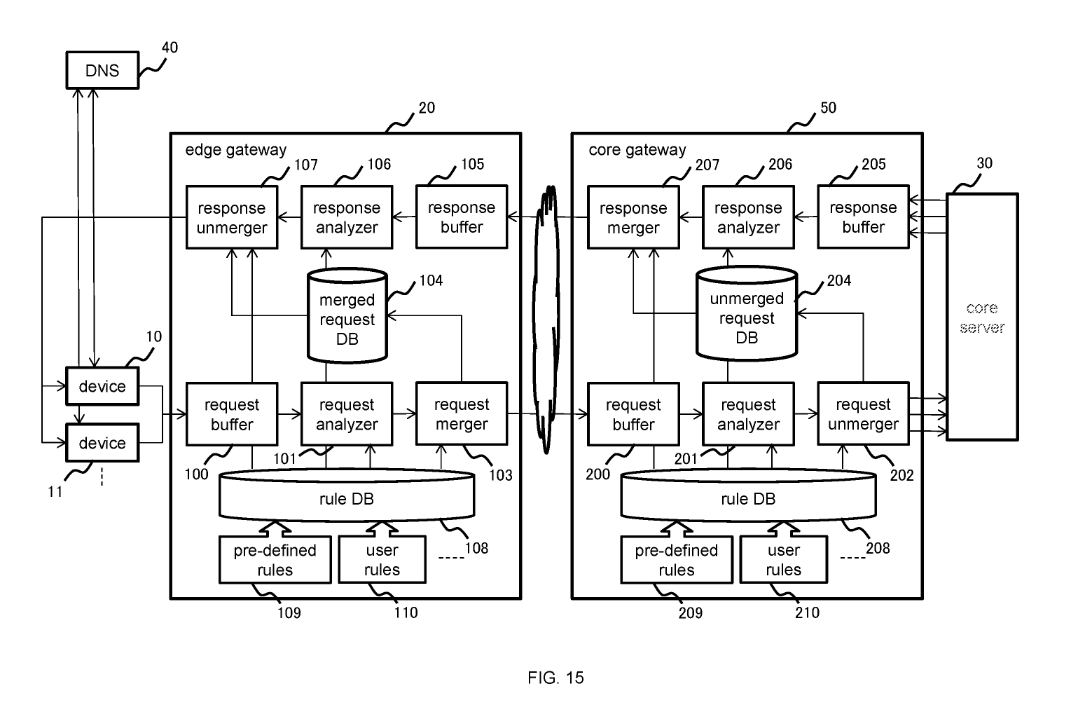

FIG. 15 illustrates an example system upon which the second example implementation may be applied. In this second example implementation, the core gateway 50 is configured to conduct the opposite of the processing of the edge gateway 20. Request buffer 200 is configured to buffer merged requests from the edge gateway 20. Request analyzer 201 is configured to analyze requests and determine whether the requests should be unmerged or not by using rule DB 208. Request unmerger 202 is configured to unmerge requests. Unmerged request DB 204 is configured to store information associated with the unmerged requests. Response buffer 205 is configured to buffer the response from core servers 30. Response analyzer 206 is configured to analyze responses and detect responses related with unmerged requests by using unmerged request DB 204 and rule DB 208. Response unmerger 207 is configured to unmerge responses related with the unmerged requests by using unmerged request DB 204 and rule DB 208. Rule DB 208 is configured to store rules regarding the merging and unmerging of requests and is pluggable with pre-defined 209 and user defined rules 210.

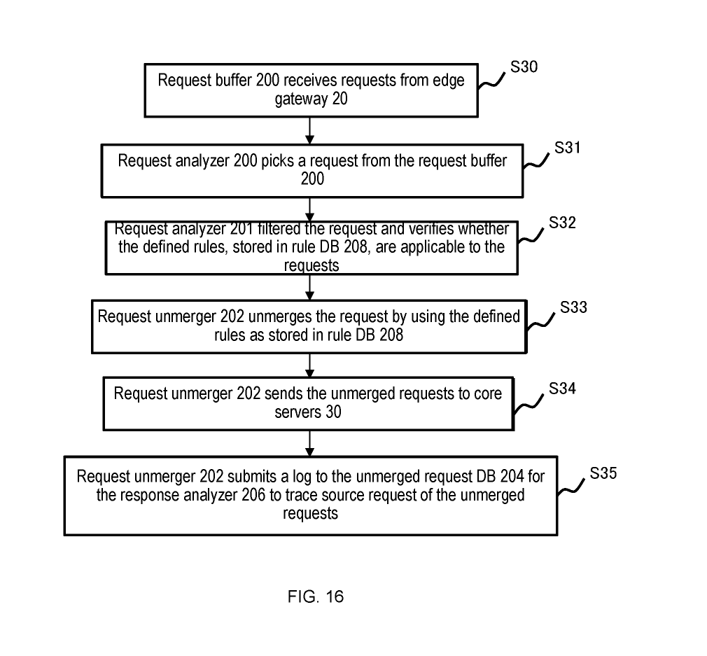

FIG. 16 illustrates an example flow chart of the core gateway 50 for unmerging requests and sending the unmerged requests to core servers 30, in accordance with a second example implementation. First of all, the request buffer 200 receives request from the edge gateway 20 (S30). The request analyzer 201 selects a request from the request buffer 200 (S31). The request analyzer 201 filtered the request and verifies whether the defined rules, stored in rule DB 208, are applicable to the requests (S32). The request unmerger 202 unmerges the request by using the defined rules as stored in rule DB 208 and applying the corresponding rule in an inverse manner (S33). The request unmerger 202 sends the unmerged requests to core servers 30 (S34). Finally, the request unmerger 202 submits a log to the unmerged request DB 204 for the response analyzer 206 to trace source request of the unmerged requests (S35).

In an example implementation of FIG. 16, suppose the merged request corresponding to the applied rule FR01 from FIG. 11 is provided to the request buffer 200 at S30. The request analyzer 201 selects the merged request from the request buffer 200 at S31 and determines that filter rule FR01 is applicable to the request at S32. The request unmerger 202 unmerges the request through a reverse application of rule FR01, whereupon the unmerged requests are provided to both the core server 30 for generating a response and to unmerged request DB 204 as illustrated in FIG. 21.

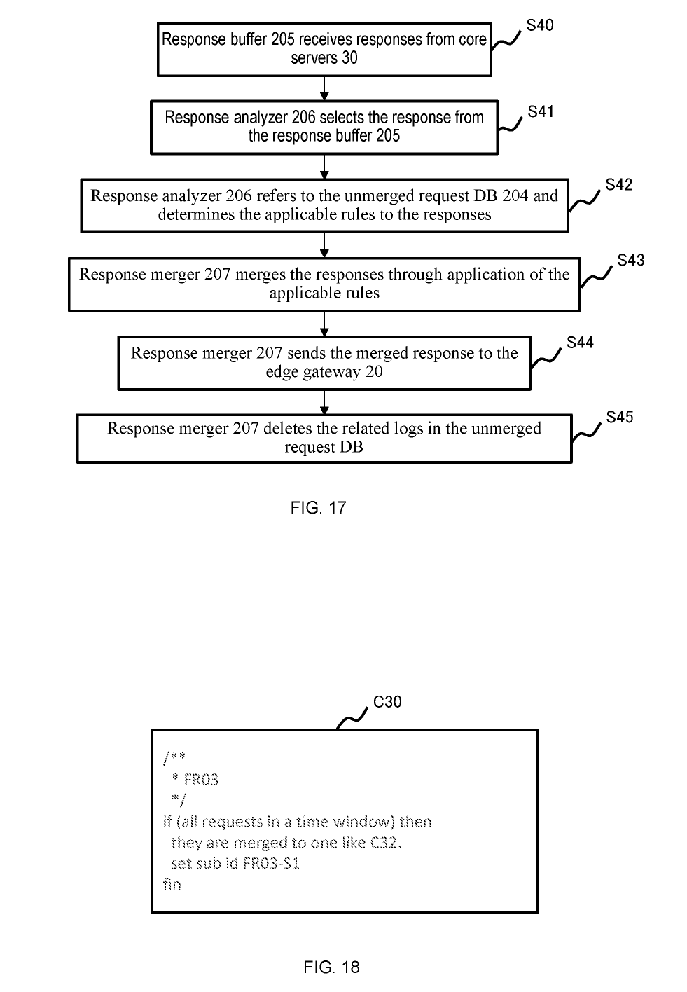

FIG. 17 illustrates a flow chart of the core gateway 50 for merging responses from core servers 30, in accordance with a second example implementation. In the second example implementation, the merging of responses involves responses to the unmerged requests, and sending the re-merged response to edge gateway 20. First of all, the response buffer 205 receives responses from core servers 30 (S40). The response analyzer 206 selects the response from the response buffer 205 (S41). The response analyzer 206 refers to the unmerged request DB 204 and determines the applicable rules to the responses (S42). The response merger 207 merges the responses through application of the applicable rules (S43). The response merger 207 sends the merged response to the edge gateway 20 (S44). Finally, the response merger 207 deletes the related logs in the unmerged request DB (S45).

FIGS. 18 through 20 illustrate examples of filter rule FR03, in accordance with a second example implementation. In this example, the filter rule FR03 is adopted when devices send their sensed data to core servers via a URL query. Filter rule FR03 is associated with site ID S05 from table T20.

FIG. 18 illustrates an example of filter rule FR03, which is identified as pseudo code example C30. This rule shows the merging rule for the edge gateway 20. In this case, FR03 has only one sub rule, which means all requests are merged as one as shown in the pseudo code example C32 by the request merger 102. The request merger 102 also sets sub ID FR03-S1 to identify what rule has been adopted.

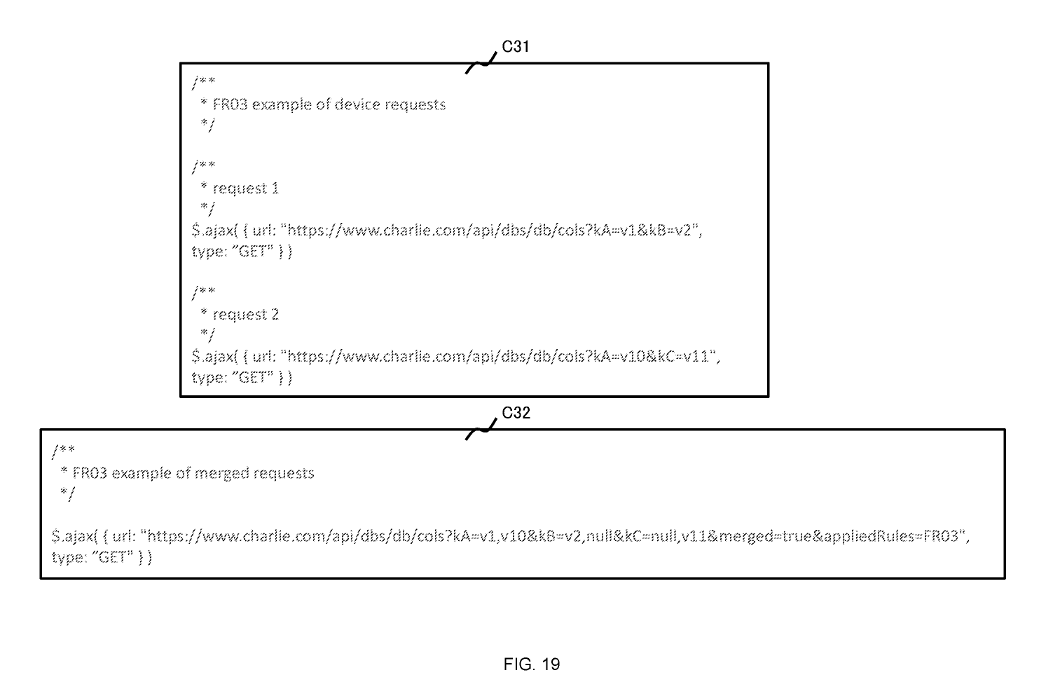

FIG. 19 illustrates an example for the edge gateway 20 to merge requests, in accordance with a second example implementation. Specifically, FIG. 19 illustrates two pseudo code example C31 and C32 and the execution of the flow at S33 of FIG. 16 by core gateway 50. C31 contains two requests, each of which is sent from different devices or from the same devices at different times. In this example, each of the requests is sent via an HTTP GET method and contains a URL query with sensed data. The first request involves data with value “v1” in key “kA” and value “v2” in key “kB”, and includes second data with value “v10” in key “kA” and “v11” in “kB”. C32 makes a merged request which merges two values for each of the corresponding keys. FIG. 19 further illustrates an example for the core gateway 50 to unmerge the merged requests, which is opposite to the processing of edge gateway 20. In the example of FIG. 19, the core gateway 50 is configured to generate C31 from C32 through an inverse application of filter rule FR03 through the execution of the flow at S33. As the filter rules can be implemented as scripts, the inverse application of the filter rules can be conducted as scripts as well according to any desired implementation.

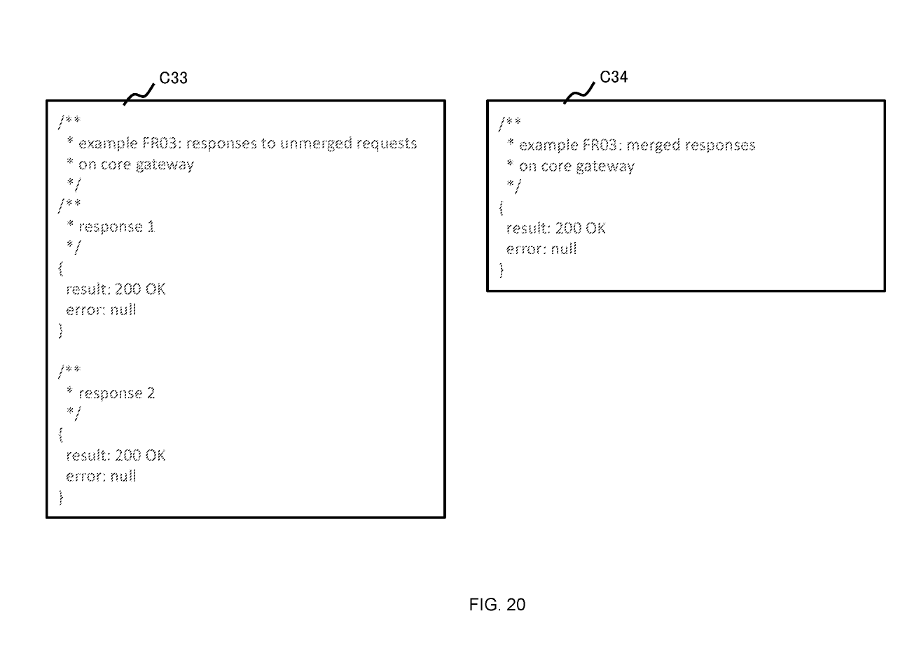

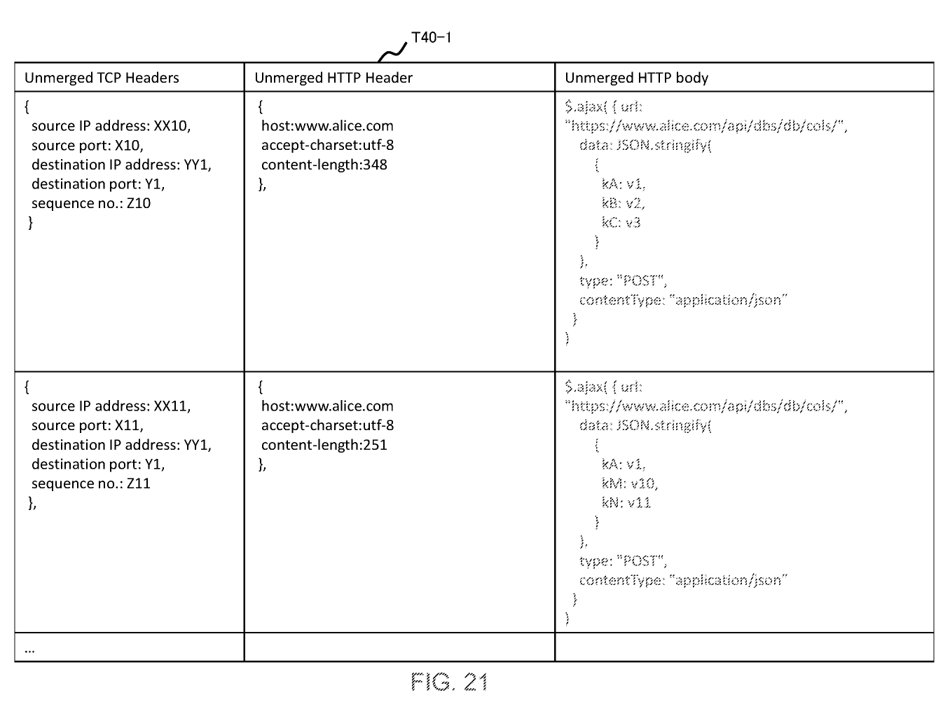

FIG. 20 illustrates an example for the core gateway 50 to merge responses, in accordance with a second example implementation. FIG. 20 illustrates two pseudo code examples C33 and C34. C33 has two responses, and the core gateway 50 merges two responses in C33 to C34. FIG. 20 also illustrates an example for the edge gateway 20 to unmerge the merged response, which is the opposite of the processing of core gateway 50. The edge gateway 20 generates C33 from C34 through an inverse application of filter rule FR03 and from the merged request DB 104 to determine the corresponding devices.

FIG. 21 illustrates examples of unmerged requests, in accordance with an example implementation. In the example of FIG. 21, the unmerged requests are managed in a table T40-1 as managed in the unmerged request DB 204 in the second example implementation. Similar implementations of unmerged request table T40-1 can also be applied to request buffer 100 in the first and second example implementation, as well as the request buffer 200 in the second example implementation to manage requests received by the edge gateway 20 and the core gateway 50 respectively. In the example of FIG. 21, each request contains header information such as TCP headers and HTTP headers, as well as body information such as HTTP body. When a request is received, the request can be inserted into unmerged request table T40-1 for implementations of the request buffer 100 and request buffer 200. In the implementations involving the unmerged request DB 204, table T40-1 is utilized to track the requests associated with the merged request when request unmerger 202 submits a log to the unmerged request DB 204 for the response analyzer 206.

In the example of FIG. 21, the unmerged requests correspond to the first merged request from FIG. 11, upon which rule FR01 is applied. When response merger 207 sends the merged response to the edge gateway 20 responsive to the requests, the entries as illustrated in FIG. 21 is deleted as the requests correspond to the response provided to the edge gateway 20.

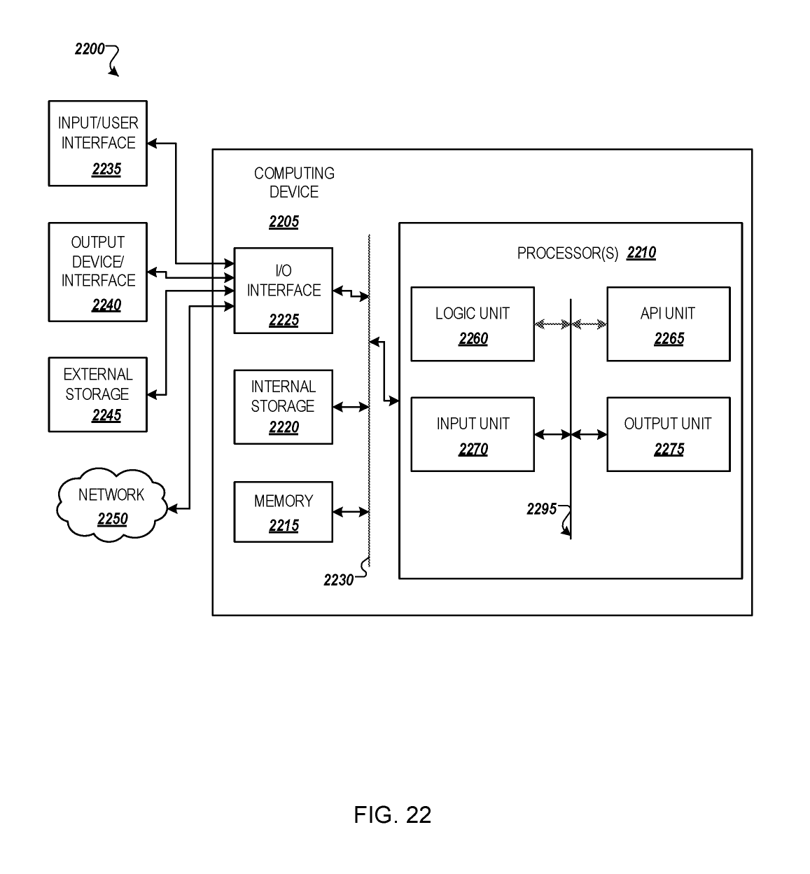

FIG. 22 illustrates an example computing environment with an example computer device suitable for use in some example implementations, such as an apparatus to facilitate the implementation of the edge gateway 20 as illustrated in FIG. 1 or FIG. 15, and/or the core gateway 50 as illustrated in FIG. 15.

Computer device 2205 in computing environment 2200 can include one or more processing units, cores, or processors 2210, memory 2215 (e.g., RAM, ROM, and/or the like), internal storage 2220 (e.g., magnetic, optical, solid state storage, and/or organic), and/or I/O interface 2225, any of which can be coupled on a communication mechanism or bus 2230 for communicating information or embedded in the computer device 2205.

Computer device 2205 can be communicatively coupled to input/user interface 2235 and output device/interface 2240. Either one or both of input/user interface 2235 and output device/interface 2240 can be a wired or wireless interface and can be detachable. Input/user interface 2235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 2240 may include a display, television, monitor, printer, speaker, braille, or the like. In some example implementations, input/user interface 2235 and output device/interface 2240 can be embedded with or physically coupled to the computer device 2205. In other example implementations, other computer devices may function as or provide the functions of input/user interface 2235 and output device/interface 2240 for a computer device 2205.

Examples of computer device 2205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 2205 can be communicatively coupled (e.g., via I/O interface 2225) to external storage 2245 and network 2250 for communicating with any number of networked components, devices, and systems, including one or more computer devices of the same or different configuration. Computer device 2205 or any connected computer device can be functioning as, providing services of, or referred to as a server, client, thin server, general machine, special-purpose machine, or another label.

I/O interface 2225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 2200. Network 2250 can be any network or combination of networks (e.g., the Internet, local area network, wide area network, a telephonic network, a cellular network, satellite network, and the like).

Computer device 2205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 2205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 2210 can execute under any operating system (OS) (not shown), in a native or virtual environment. One or more applications can be deployed that include logic unit 2260, application programming interface (API) unit 2265, input unit 2270, output unit 2275, and inter-unit communication mechanism 2295 for the different units to communicate with each other, with the OS, and with other applications (not shown). The described units and elements can be varied in design, function, configuration, or implementation and are not limited to the descriptions provided.

In some example implementations, when information or an execution instruction is received by API unit 2265, it may be communicated to one or more other units (e.g., logic unit 2260, input unit 2270, output unit 2275). In some instances, logic unit 2260 may be configured to control the information flow among the units and direct the services provided by API unit 2265, input unit 2270, output unit 2275, in some example implementations described above. For example, the flow of one or more processes or implementations may be controlled by logic unit 2260 alone or in conjunction with API unit 2265. The input unit 2270 may be configured to obtain input for the calculations described in the example implementations, and the output unit 2275 may be configured to provide output based on the calculations described in example implementations.

In either the first example implementation or the second implementation, there is a system that involves a first apparatus such as edge gateway 20. In such an implementation, memory 2215 can be configured to manage a plurality of rules and a plurality of sub-rules for merging requests, which can include the management of the site information as illustrated in FIG. 5 or the rule DB 108 as illustrated in FIG. 6. Memory 2215 can be configured to store requests in a request buffer 100 from one or more devices 10, 11.

In an example implementation involving an edge gateway 20, processor(s) 2210 can be configured to execute the flow as illustrated in FIG. 2 to receive a plurality of requests (e.g. from IoT devices 10, 11) wherein each of the plurality of requests includes header information (e.g., such as TCP header information or HTTP header information) and body information (e.g., such as HTTP body information) as illustrated in FIG. 21. Processor(s) 2210 are then configured to execute request analyzer 101 to select a rule from the plurality of rules in the memory 2215 for the plurality of requests, based on the header information of the plurality of requests and the rules stored in the rule DB 108. For example, if the header information for the requests indicates that the user ID is U10, target site is S02 and domain name is ‘www.alice.com’, then based on the information of FIG. 5, the processor(s) 2210 apply filter rule FR02 to the requests, as well as to requests received within the same time window for target site S03 for user U11 and domain name of ‘www.bob.com’. Processor(s) 2210 then select sub-rules from ones of the plurality of sub-rules corresponding to the selected rule in the memory 2215 for the plurality of requests, based on the body information of the plurality of requests. As illustrated in FIG. 7, rules in the rule DB 108 may be associated with sub-rules that are executed on the body information (e.g., HTTP body, JSON object) of the request, and one of the sub-rules is selected for determining how to merge the body information of the plurality of requests. Processor(s) 2210 can then generate a merged request from an execution of a merger operation on the plurality of requests (e.g., such as request merger 102) based on the selected rule and the selected sub-rule as illustrated in FIG. 8 and FIG. 10; and transmit the merged request to a second apparatus such as core gateway 50 or core server 30.

The merged request can be stored by memory 2215, wherein the merged requests are managed by memory 2215 in the form of a merged request DB 104 as illustrated in FIG. 11. Processor(s) 2210 can be configured to, for receipt of one or more responses from the second apparatus (either from core gateway 50 or core server 30), select a response corresponding to the merged request in the memory 2215 through use of response analyzer 106 to determine which of the merged requests stored in the merged request DB 104 correspond to the responses received in the response buffer 105. Processor(s) 2210 can further be configured to execute response unmerger 107 to generate a plurality of unmerged responses from the selected response based on an application of the selected rule and the selected sub-rule associated with the response through a lookup of merged request DB 104 to determine which rule is applied, and then doing an inverse application of the rules therein to generate the unmerged responses as shown in FIG. 21. Processor(s) 1210 can then transmit the unmerged responses to the corresponding one or more devices.

As illustrated for merged request DB 104 at FIG. 11, and as illustrated in FIG. 5 and FIG. 6, memory 2215 can be configured to manage a database having an association between the merged request, the selected rule, and the selected sub-rule, and processor(s) 2210 can be configured to generate the association in the database upon generation of the merged request. Processor(s) 2210 can be configured to determine the selected rule and the selected sub-rule associated with the merged request in the memory 2215 for the selected response from the response buffer 105 based on the association in the database as illustrated by response analyzer 106 doing a lookup to merged request DB 104 in FIG. 11.

Processor(s) 2210 can also be configured to receive the plurality of requests from a selection of requests received within a time window, wherein a subsequent time window is determined based on which of the requests received within the time window are selected for the merger operation as illustrated in FIG. 14.

As illustrated in FIG. 1, computer device 2205 can be implemented in the form of an edge gateway 20 configured to manage a plurality of internet of things (IoT) devices 10, 11, the plurality of requests received from one or more of the plurality of IoT devices 10, 11, and the second apparatus is a core server 30, or a core gateway 50.

In a second example implementation whereby computer device 2205 is implemented for core gateway 50, processor(s) 2210 can be configured to unmerge the merge request into the plurality of requests based on the selected rule and the selected sub-rule through the execution of the flow of FIG. 16 and transmit the plurality of requests to a third apparatus such as the core server 30. For receipt of a plurality of responses in response buffer 205 to the plurality of requests from the core server 30, processor(s) 2210 can be configured to execute response merger 207 to generate a merged response from an execution of a merger operation on the plurality of responses based on the selected rule and the selected sub-rule; and transmit the merged response to the first apparatus such as the edge gateway 20.

In a second example implementation whereby computer device 2205 is implemented for core gateway 50, memory 2215 can be configured to store the unmerged requests as illustrated in FIG. 21 and to manage the plurality of rules and the plurality of sub-rules for merging requests as illustrated by rule DB 208 and FIGS. 5 and 6. Processor(s) 2210 can be configured to determine the selected rule from the plurality of rules in the memory 2215 for the plurality of requests, based on the header information of the plurality of requests; and determine the selected sub-rule from ones of the plurality of sub-rules corresponding to the selected rule in the memory for the plurality of requests, based on the body information of the plurality of requests in the exact same manner as described above for edge gateway 20.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system, comprising:
a first apparatus, comprising:
a memory, configured to manage a plurality of rules and a plurality of sub-rules for merging requests; and
a processor, configured to:
receive a plurality of requests, each of the plurality of requests comprising header information and body information;
select a rule from the plurality of rules in the memory for the plurality of requests, based on the header information of the plurality of requests;
select a sub-rule from ones of the plurality of sub-rules corresponding to the selected rule in the memory for the plurality of requests, based on the body information of the plurality of requests;
generate a merged request from an execution of a merger operation on the plurality of requests based on the selected rule and the selected sub-rule; and
transmit the merged request to a second apparatus.

2. The system of claim 1, wherein the memory is configured to manage the merge request, and wherein the processor is configured to:
for receipt of one or more responses from the second apparatus, select a response corresponding to the merged request in the memory;
generate a plurality of unmerged responses from the selected response based on an application of the selected rule and the selected sub-rule; and
transmit the unmerged responses to corresponding one or more devices.

3. The system of claim 2, wherein the memory is configured to manage a database comprising an association between the merged request, the selected rule, and the selected sub-rule;
wherein the processor is configured to generate the association in the database upon generation of the merged request;
wherein the processor is configured to determine the selected rule and the selected sub-rule associated with the merged request in the memory for the selected response based on the association in the database.

4. The system of claim 1, wherein the processor is configured to receive the plurality of requests from a selection of requests received within a time window, wherein a subsequent time window is determined based on which of the requests received within the time window are selected for the merger operation.

5. The system of claim 1, wherein the first apparatus is an edge gateway configured to manage a plurality of internet of things (IoT) devices, the plurality of requests received from one or more of the plurality of IoT devices, and the second apparatus is a core gateway.

6. The system of claim 5, wherein the second apparatus comprises:
another processor, configured to:
unmerge the merge request into the plurality of requests based on the selected rule and the selected sub-rule;
transmit the plurality of requests to a third apparatus;
for receipt of a plurality of responses to the plurality of requests from the third apparatus, generate a merged response from an execution of a merger operation on the plurality of responses based on the selected rule and the selected sub-rule; and
transmit the merged response to the first apparatus.

7. The system of claim 6, wherein the second apparatus comprises:
another memory, configured to store the unmerged requests and to manage the plurality of rules and the plurality of sub-rules for merging requests;
and wherein the another processor is configured to:
determine the selected rule from the plurality of rules in the memory for the plurality of requests, based on the header information of the plurality of requests; and
determine the selected sub-rule from ones of the plurality of sub-rules corresponding to the selected rule in the memory for the plurality of requests, based on the body information of the plurality of requests.

8. A method, comprising:
managing a plurality of rules and a plurality of sub-rules for merging requests;
receiving a plurality of requests, each of the plurality of requests comprising header information and body information;
selecting a rule from the plurality of rules for the plurality of requests, based on the header information of the plurality of requests;
selecting a sub-rule from ones of the plurality of sub-rules corresponding to the selected rule for the plurality of requests, based on the body information of the plurality of requests;
generating a merged request from an execution of a merger operation on the plurality of requests based on the selected rule and the selected sub-rule; and
transmitting the merged request to an apparatus.

9. The method of claim 7, further comprising:
managing the merge request;
for receipt of one or more responses from the apparatus, selecting a response corresponding to the managed merge request;
generating a plurality of unmerged responses from the selected response based on an application of the selected rule and the selected sub-rule; and
transmitting the unmerged responses to corresponding one or more devices.

10. The method of claim 9, further comprising:
managing a database comprising an association between the merged request, the selected rule, and the selected sub-rule, wherein the association is generated in the database upon generation of the merged request;
wherein the determining the selected rule and the selected sub-rule associated with the managed merged request for the selected response is based on the association in the database.

11. The method of claim 7, wherein the receiving the plurality of requests is based from a selection of requests received within a time window, wherein a subsequent time window is determined based on which of the requests received within the time window are selected for the merger operation.

12. The method of claim 7, wherein the plurality of requests are received from one or more internet of things (IoT) devices, and wherein the apparatus is a core gateway.

13. The method of claim 12, further comprising:
unmerging, at the apparatus, the merge request into the plurality of requests based on the selected rule and the selected sub-rule; and
transmitting, the plurality of requests from the apparatus to another apparatus;
for receipt of a plurality of responses to the plurality of requests from the another apparatus, generating, at the apparatus, a merged response from an execution of a merger operation on the plurality of responses based on the selected rule and the selected sub-rule; and
receiving the merged response from the apparatus.

14. The method of claim 13, further comprising:
managing, at the apparatus, the unmerged requests, the plurality of rules and the plurality of sub-rules for merging requests;
determining, at the apparatus, the selected rule from the plurality of rules for the plurality of requests, based on the header information of the plurality of requests; and
determining, at the apparatus, the selected sub-rule from ones of the plurality of sub-rules corresponding to the selected rule for the plurality of requests, based on the body information of the plurality of requests.

15. A non-transitory computer readable medium, storing instructions for executing a process, the instructions comprising:
managing a plurality of rules and a plurality of sub-rules for merging requests;
receiving a plurality of requests, each of the plurality of requests comprising header information and body information;
selecting a rule from the plurality of rules for the plurality of requests, based on the header information of the plurality of requests;
selecting a sub-rule from ones of the plurality of sub-rules corresponding to the selected rule for the plurality of requests, based on the body information of the plurality of requests;
generating a merged request from an execution of a merger operation on the plurality of requests based on the selected rule and the selected sub-rule; and
transmitting the merged request to an apparatus.
